(19) United States
(12) Patent Application Publication
(10) Pub. No.: US 2009/0301653 A1
(43) Pub. Date: Dec. 10, 2009

(54) APPARATUS AND PROCESS FOR PRODUCING DOCUMENT CORE INLAYS

(75) Inventor: Chi Keung Lee, Hong Kong (CN)

Correspondence Address: BROOKS KUSHMAN P.C., 1000 TOWN CENTER, TWENTY-SECOND FLOOR, SOUTHFIELD, MI, 48075, US

(73) Assignee: On Track Innovations Ltd., Rosh Pina (IL)

(21) Appl. No.: 12/162,252

(22) PCT Filed: Jan. 25, 2006
(86) PCT No.: PCT/CN06/00137

§ 371 Date: Dec. 16, 2008

(51) Int. Cl. B32B 37/00; B23K 37/00

(52) U.S. Cl. 156/281; 156/538; 156/378; 228/18; 156/60

(57) ABSTRACT

An apparatus for processing a document core sheet to produce a document core inlay may include a plurality of processing stations, each for executing at least one step in producing the document core inlay, and at least one supporting table for supporting the core sheet and for transporting the core sheet to each processing station for processing. The processing stations may be positioned surrounding a center such that a closed-loop path is defined. The table may travel along the closed-loop path among the processing stations.

### FIELD OF THE INVENTION

The present invention relates to technologies for producing document core inlays.

### BACKGROUND OF THE INVENTION

A document may include an integrated circuit embedded or inlaid in a sheet of the document. In an exemplary embodiment, the document may be, for example, a passport, travel document, identification document, or other security document. A travel document core inlay producing apparatus may incorporate a plurality of processing stations, each for executing at least one step in processing a travel document core sheet into the travel document core inlay. A processing station may include a loading station for loading the core sheet, a module placement station for placing an integrated circuit chip module onto the core sheet, a wire embedding station for laying wires onto the core sheet for electrical connection purpose, a spot welding station for welding the wires to establish electrical connections with the chip module, and an unloading station for unloading the produced core inlay.

Conventionally, the various processing stations may be sequentially arranged along a linear rail. A supporting table may support the core sheet during processing as the core sheet moves from one station to another along the rail. The apparatus may include a mechanism and/or step of recycling the supporting table back to the beginning of the rail to process the next core sheet. The size of such a machine may be more bulky than desired.

### SUMMARY OF THE INVENTION

Therefore, it is an object of the present invention to provide a relatively compact document core inlay producing apparatus and process, or at least provide the public with a useful choice.

According to an aspect of the present invention, an apparatus for processing a document core sheet to produce a document core inlay includes a plurality of processing stations, each for executing at least one step in producing the travel document core inlay, and at least one supporting table for supporting the core sheet and for transporting the core sheet to each processing station for processing. The processing stations are positioned surrounding a center such that a closed-loop path is defined, and the table travels along the closed-loop path among the processing stations.

According to another aspect of the present invention, a process for processing a core inlay in a core sheet includes:

providing a core sheet;

sequentially cycling the core sheet to a plurality of processing stations along the closed loop path;

processing the core sheet at each of the successive processing stations,

wherein the processing includes providing a core inlay for the core sheet.

Other aspects and advantages of the invention will become apparent from the following detailed description, taken in conjunction with the accompanying drawings, which description illustrates by way of example the principles of the invention. Other features which are also considered as characteristic for the invention are set forth in the appended claims.

### BRIEF DESCRIPTION OF THE DRAWINGS

FIG. 1 illustrates a simplified top plan view of an exemplary embodiment travel document core inlay producing apparatus;

FIG. 2 illustrates an exemplary process of operation for an exemplary embodiment of a core inlay producing apparatus;

FIG. 3 illustrates an exemplary embodiment of a loading station;

FIG. 4a illustrates a simplified top plan view of an exemplary embodiment of the turntable of the apparatus of FIG. 1;

FIG. 4b illustrates a cross sectional view of an exemplary embodiment of the turntable of FIG. 4a, along line A-A′;

FIG. 5 illustrates a simplified top plan view of an exemplary embodiment of a document core inlay producing apparatus; and

FIG. 6 illustrates a simplified top plan view of an exemplary embodiment of a document core inlay producing apparatus.

### DETAILED DESCRIPTION OF THE PREFERRED EMBODIMENTS

In the following detailed description and in the several figures of the drawing, like elements are identified with like reference numerals

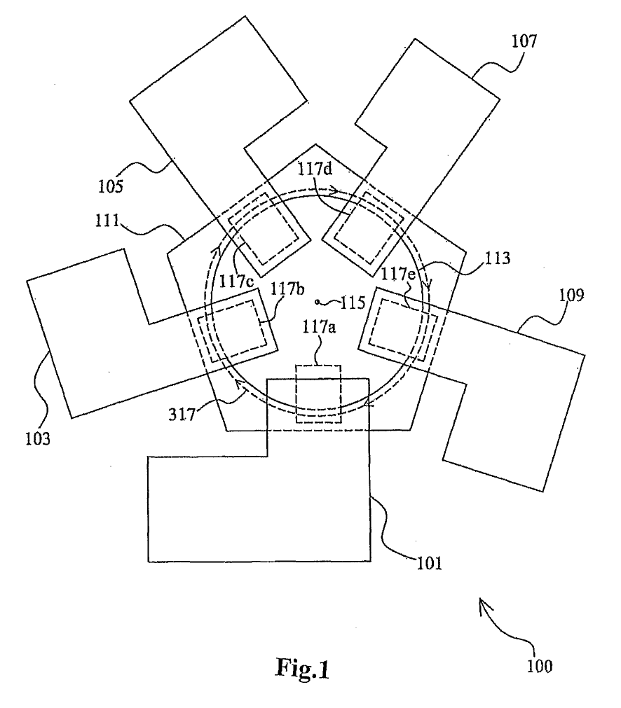

FIG. 1 illustrates an exemplary embodiment of a document core inlay producing apparatus 100. The core inlay producing apparatus 100 may include a plurality of processing stations, for example, a loading station 101, a module placement station 103, a wire embedding station 105, a spot welding station 107, and an unloading station 109.

In an exemplary embodiment, the processing stations may be integrated into a platform 111 and may be positioned along a circumference of a circular turntable 113. In an exemplary embodiment, the processing stations may be positioned substantially evenly along the circumference. In an exemplary embodiment, the turntable 113 may be rotatable about a center or axis 115.

In an exemplary embodiment, the turntable 113 may have a plurality, for example five, supporting tables 117a-e thereon. In an exemplary embodiment, the supporting tables may be evenly distributed along the circumference. In an exemplary embodiment, the supporting tables may be positioned such that they may be fed into a respective working region of the processing stations simultaneously. In an exemplary embodiment, the path of the support tables 117a-e may define a closed loop path 317 as the turntable is rotated through all of the processing stations 101-109.

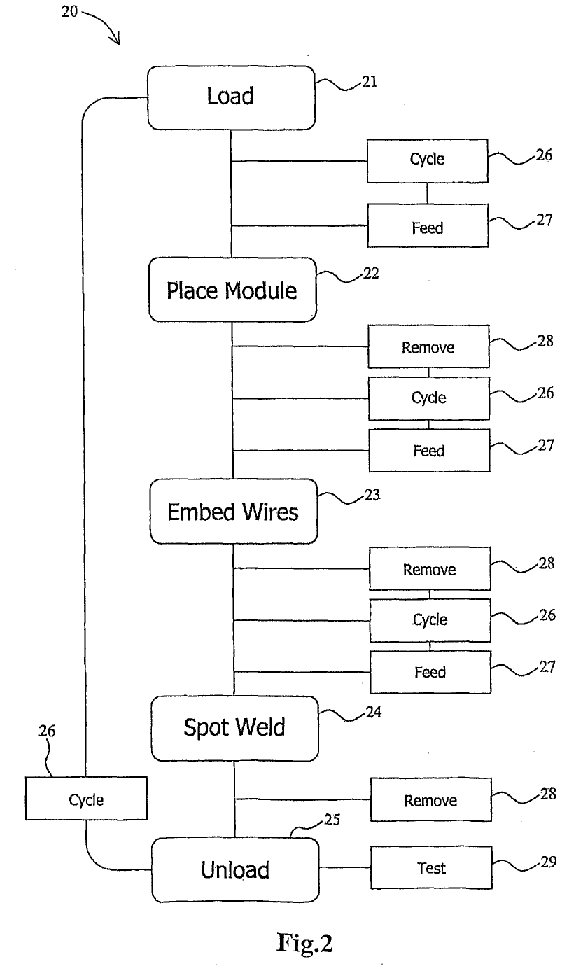

FIG. 2 illustrates an exemplary process 20 of producing a core inlay for a document. In an exemplary embodiment, the process 20 may include loading 21 an unprocessed core sheet, placing 22 a module or chip in the core sheet, embedding 23 wires for making an electrical connection to the chip, welding 24, for example spot welding, for attaching the wires to connections on the module or chip, and unloading 25 the chip from the apparatus. In an exemplary embodiment, loading 21 may be done first, placing 22 the module or chip second, embedding 23 wires third, welding 24 fourth and unloading 25 may be performed last.

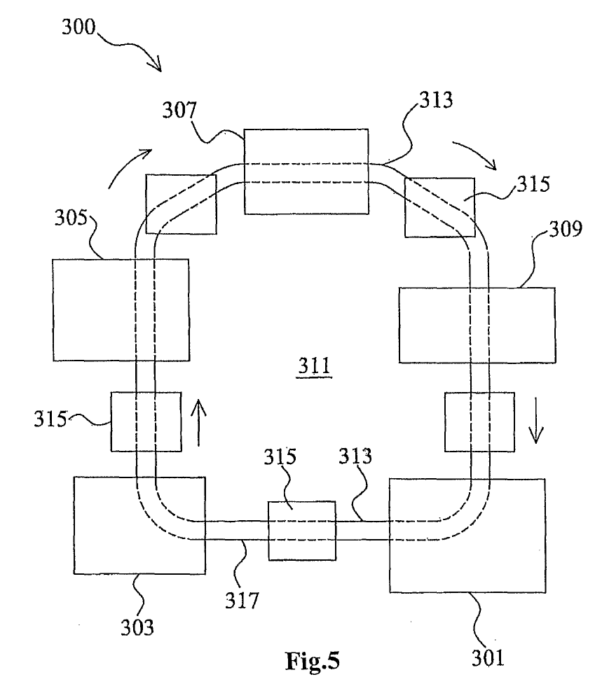

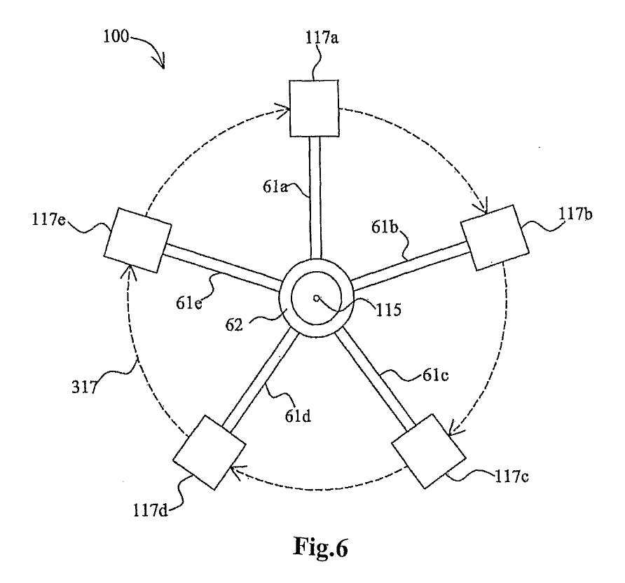

In an exemplary embodiment, the process may include cycling 26 the core sheet from one processing station to the next. In an exemplary embodiment, the core sheet or sheets may be cycled 26 from one processing station to the next by rotating the turntable a sufficient number of degrees for a core sheet or sheets to reach the next processing station. In an exemplary embodiment, with a circular rotation and five evenly spaced processing stations, the core sheets may be cycled 26 to a subsequent processing station by rotating a turntable by 72 degrees. In an exemplary embodiment, as described below with respect to FIGS. 5 and 6, the core sheet may be cycled 26 from one processing station to a subsequent processing station by moving a support table 315 (FIG. 5) on a closed loop rail 313 (FIG. 5) or track or by rotating arms 61a-e (FIG. 6) holding the supporting tables 117a-e by the desired number of degrees about a center structure or axis.

In an exemplary embodiment, the process may further include feeding the core sheet into a working region of a processing station. For example, when the core sheet has been cycled to a new processing station such as, for example, the module placing station, wire embedding station and/or the spot welding station, the core sheet may then be fed into a working region of the respective processing station. In an exemplary embodiment, the process may include removing the core sheet from the working region of the respective processing station after the respective processing has been performed and prior to cycling the core sheet to a subsequent processing station.

### Loading Station

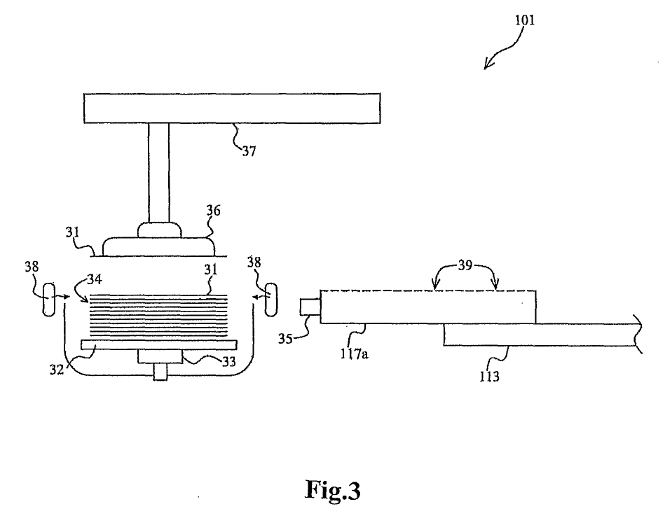

FIG. 3 illustrates an exemplary embodiment of a loading station 101. In an exemplary embodiment, an unprocessed core sheet 31 may be loaded from an input tray 32 of the loading station 101 onto supporting table 117a. In an exemplary embodiment, a loading station 101 may have a lift table 33 for raising a core sheet stack 34 in its input tray 32 to a level approximately the same as the supporting table 117a, as determined by a photo sensor 35 mounted thereon. In an exemplary embodiment, a suction mechanism 36 may suck up the top core sheet by vacuum, and a transfer unit 37 may subsequently feed the picked core sheet onto the respective supporting table 117a on the turntable 113. In an exemplary embodiment, air 38 may be blown from the sides of the lift table to ensure appropriate paper separation.

### Module Placing Station

In an exemplary embodiment, as the turntable 113 may cycle 26 (FIG. 2) or rotate into position, an unprocessed core sheet may be fed 27 (FIG. 2) into a working region of the module placement station 103, where an integrated circuit chip module (not shown) may be mounted onto the core sheet (now shown). In an exemplary embodiment with five stations, for example, the turntable 113 may rotate by 72 degrees.

### Wire Embedding Station

In an exemplary embodiment, the core sheet may then be fed 27 to the wire embedding station 105 by cycling 26 or rotating the turntable 113, for example by 72 degrees, such that the wire embedding station 105 may lay wires (not shown) onto the core sheet for providing a electrical connection to the module or chip.

### Spot Welding Station

In an exemplary embodiment, the core sheet may then be removed 28 and cycled 26 or rotated to a spot welding station 107. In an exemplary embodiment, the wires may be welded to establish electrical connections with the chip module by the spot welding station 107. In an exemplary embodiment, at this stage of an exemplary process, the core sheet may have been produced into a finished core inlay.

### Unloading Station

In an exemplary embodiment, the turntable 113 may then by cycled 26 or rotated an appropriate number of degrees, for example by 72 degrees, to feed the produced core inlay into the unloading station 109, which may then unload the produced core inlay and may empty the supporting table. In an exemplary embodiment, the emptied supporting table may then be cycled 26 or rotated to the loading station 101 to start a new production cycle 20.

In the exemplary embodiment, a testing 29 function may be integrated into the unloading station.

In an exemplary embodiment, a core inlay producing apparatus may be arranged in a relative compact structure by arranging the processing stations around a center. In an exemplary embodiment, a core inlay producing apparatus may define a closed-loop path connecting the processing stations. In an exemplary embodiment, a closed-loop path apparatus may facilitate feeding a supporting table 117d in the unloading station 109 to the loading station 101 for a subsequent next cycle.

In an exemplary embodiment, providing a core inlay producing apparatus with a plurality of supporting tables 117a-e, may facilitate processing a plurality of core sheets simultaneously. For example, in an exemplary embodiment with five supporting tables 117a-3, as shown in FIG. 1, it may be possible to process up to five core sheets simultaneously.

In an exemplary embodiment, each of the separate processing stations may have an independent security system. In an exemplary embodiment, providing processing stations with independent security systems may permit each processing station to be controlled separately.

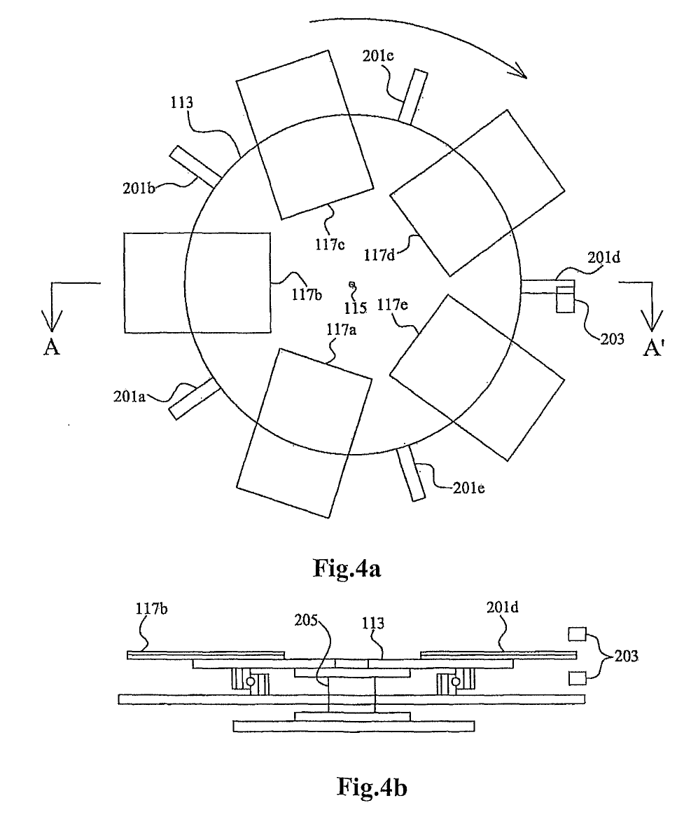

In an exemplary embodiment, a turntable 113, for example as shown in FIGS. 4a and 4b, may be rotatably mounted to a pivot or column 205 at its center 115. In an exemplary embodiment, a turntable may have a plurality of blocks 201a-e. In an exemplary embodiment, the blocks 201a-e may work together with a laser micrometer 203 mounted on the integrated platform 111 (FIG. 1) for positioning the turntable 113.

In an exemplary embodiment, a supporting table, for example each supporting table, may have vacuum holes 39 (FIG. 3) thereon for flatting the core sheet thereon and for maintaining the core sheet in contact with the supporting such that during the processing, the core sheet remains on the supporting table without being lifted. In an exemplary embodiment, the vacuum holes may facilitate or assist in achieving a desired production quality by reducing the possibility of inadvertent movement of the core sheet.

FIG. 5 illustrates an exemplary embodiment of a processing apparatus 300. In an exemplary embodiment, the apparatus 300 may include a plurality of processing stations 301, 303, 305, 307, 309. In an exemplary embodiment, the processing stations may perform functions similar to those processing stations shown and described with respect to FIGS. 1-3. In an exemplary embodiment, the processing stations may be positioned about the center 311 such that the closed-loop path 317 connecting the processing stations 301-309 exhibits an irregular shape.

In an exemplary embodiment, the processing stations may be connected by a rail 313, which defines the closed-loop path 317. In an exemplary embodiment, the supporting table(s) 315 may be driven along the rail 313 among the processing stations 301-309 by, for example, gear and gear track (both not shown) each mounted on one of the rail and the supporting table, belt, and so on, as could be understood in the art.

Various alternate embodiments to the above-described embodiments may also be made.

For example, referring to FIG. 3, the loading station 101 may use a positioning unit (not shown) before the supporting table 117a to ensure that the core sheet is well positioned. After the core sheet is loaded onto a platform (not shown) of the positioning unit, for example, by the transfer unit 37, a pair of moving plates (not shown) on the positioning unit push the two tailing edges of the core sheet towards a pair of fixed edges or stoppers (not shown) on the supporting table until the two leading edges of the top sheet have reached the fixed edges so that a repeatable positioning for core sheets on the supporting tables can be achieved. Air may be blown from the bottom of the positioning unit to reduce the friction between the core sheet being fed and the platform of the positioning unit.

FIG. 6 illustrates an exemplary embodiment of a document core inlay producing apparatus 100. In an exemplary embodiment, the apparatus 100 may include a plurality of support tables 117a-117e for supporting a core sheet during processing. In an exemplary embodiment, the support tables 117a-117e may be mounted or attached on arms 61a-61e. In an exemplary embodiment, the arms 61a-61e may be mounted on a center structure 62. In an exemplary embodiment, the center structure 62 may be rotatable about an axis 115. In an exemplary embodiment, the arms 61a-61e may be mounted such that they may be rotated around the axis 115. In an exemplary embodiment, as the arms are rotated about the axis 115, the movements of the support tables 117a-e define a closed loop path 317. In an exemplary embodiment, the arms 61a-e may each have one end connected to a supporting table 117a-117e and the other end rotatably connected at the center 62 and driven by a rotation motor (not shown), which may be used to rotate the supporting tables among the processing stations 101-109 (FIG. 1). In an exemplary embodiment, the supporting tables 117a-e may be cycled 26 through successive processing stations as described above with respect to FIG. 2.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself. The definitions of the words or elements of the following claims are, therefore, defined in this specification to include not only the combination of elements which are literally set forth, but all equivalent structure, material or acts for performing substantially the same function in substantially the same way to obtain substantially the same result.

1-28. (canceled)

29. An apparatus configured to process a sheet for producing an inlay, comprising:
a) a plurality of processing stations, each for executing at least one step in producing said inlay; and
b) at least one supporting table for supporting said sheet and for transporting it to each processing station for processing, wherein said plurality of processing stations are positioned surrounding a center, such that a closed-loop path is defined, and wherein said at least one supporting table travels along said closed-loop path among said plurality of processing stations.

30. The apparatus according to claim 29, wherein the processing stations are at least substantially evenly distributed along a circumference of a circle about the center.

31. The apparatus according to claim 29, further comprising an arm with one end connected to the supporting table and the other end rotatably connected at the center.

32. The apparatus according to claim 29, further comprising a turntable rotatable about the center with the at least one supporting table thereon.

33. The apparatus according to claim 32, wherein the turntable comprises at least one position locator thereon.

34. The apparatus according to claim 29, further comprising a rail connecting the processing stations and defining the closed-loop path.

35. The apparatus according to claim 34, further comprising a gear track mounted onto one of the supporting table and rail for driving said supporting table along said rail.

36. The apparatus according to claim 29, wherein the processing stations comprises:
a) a loading station for loading the sheet;
b) a module placement station for placing one or more of the following onto said sheet:
a module;
a chip; and
a chip module;
c) a wire embedding station for laying wires onto said sheet for electrical connection purpose;
d) a welding station for welding the wires to establish electrical connections with one or more of the following:
said module;
said chip; and
said chip module; and
e) an unloading station for unloading the produced inlay.

37. The apparatus according to claim 36, wherein the unloading station also functions as a testing station.

38. The apparatus according to claim 36, wherein the processing stations are sequentially positioned, with the unloading station adjacent to the loading station.

39. The apparatus according to claim 36, wherein the loading station comprises a lift table for raising an unprocessed sheet to a level at least substantially the same as the supporting table.

40. The apparatus according to claim 36, wherein the processing stations are integrated into one single platform.

41. The apparatus according to claim 40, further comprising a turntable rotatable about the center and being integrated into the platform, the at least one supporting table is positioned on said turntable such that rotation of said turntable transports said at least one supporting table among the processing stations.

42. The apparatus according to claim 36, wherein at least one of the processing stations comprises an independent security check mechanism.

43. The apparatus according to claim 36, wherein the loading station comprises a positioning unit that receives the sheet before it is loaded onto the supporting table, and wherein said positioning unit has a pair of moving plates thereon to push the tailing edge of said sheet towards said supporting table in the working region of said loading station.

44. The apparatus according to claim 43, wherein the positioning unit further comprises air holes, through which air can be blown to reduce the friction between the sheet being fed and the positioning unit.

45. The apparatus according to claim 29, wherein the supporting table comprises a stopper for positioning the sheet fed onto said supporting table.

46. The apparatus according to claim 29, wherein the supporting table comprises vacuum holes thereon for flatting the sheet thereon.

47. A process of processing an inlay, comprising:
a) providing a sheet;
b) sequentially cycling said sheet to a plurality of processing stations along the closed loop path; and
c) processing said sheet at each of the processing stations, wherein the processing comprises providing an inlay for said sheet.

48. The process according to claim 47, wherein sequentially cycling the sheet comprises:
a) cycling the sheet to a module placement station;
b) cycling said sheet to a wire embedding station; and
c) cycling said sheet to a spot welding station.

49. The process according to claim 47, wherein processing the sheet comprises:
a) placing one or more of the following in the sheet:
a module;
a chip; and
a chip module;
b) embedding wires in said sheet; and
c) spot welding the wires to make electrical connection with one or more of the following:
said module;
said chip; and
said chip module.

50. The process according to claim 47, further comprising loading the sheet onto a support structure, wherein the support structure is cycled to the plurality of processing stations along the closed loop path.

51. The process according to claim 50, further comprising providing vacuum holes within the support structure for holding one or more of the following in place on said support structure:
a) the sheet;
b) a module placed in the sheet;
c) a chip placed in the sheet; and
d) a chip module placed in the sheet.

52. The process according to claim 47, further comprising providing within the closed loop path a turntable rotatably mounted about an axis, and cycling the sheet to the plurality of processing stations at least by rotating said turntable about said axis.

53. The process according to claim 47, further comprising providing within the closed loop path a plurality of arms rotatably attached about a center structure, and cycling the sheet to the plurality of processing stations at least by rotating the arm about said center structure.

54. The process according to claim 47, further comprising providing within the closed loop path a closed rail system, and cycling the sheet to the plurality of processing stations at least by holding said sheet on a support structure and moving said support structure along said closed rail system sequentially to each of the processing stations.
